(19) United States
(12) Patent Application Publication
(10) Pub. No.: US 2005/0235742 A1
(43) Pub. Date: Oct. 27, 2005

(54) Method for measuring cylinder specific parameters in a combustion engine

(76) Inventors: Jorgen Bengtsson, Svanskog (SE); Thomas Hammarstrom, Svanskog (SE)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(21) Appl. No.: 10/257,820

(22) PCT Filed: Apr. 17, 2001
(86) PCT No.: PCT/SE01/00835

§ 371 Date: Oct. 25, 2004

(30) Foreign Application Priority Data
Apr. 19, 2000 (SE) 0001449-8

(51) Int. Cl. G01M 15/00; G01L 3/26

(52) U.S. Cl. 73/116; 324/399

(57) ABSTRACT

The invention concerns a method to measure parameters in the combustion chamber of a piston engine that comprises an ignition system. An alternating voltage is applied across the secondary winding of the ignition coil and the value of the current that arises in a measurement circuit that co-operates with the secondary winding is measured. The value of the current depends on the resistance (R1) of the measurement circuit, on the inductance (L1) and resistance of the secondary winding, and on the impedance of the combustion chamber, i.e. on its capacitance (C1) and its resistance. For example, top dead centre, the pressure in the cylinder, analysis of the ionic current and change of the burning time can be determined by means of the method.

### TECHNICAL FIELD

The present invention concerns a method for measuring and determining cylinder-specific parameters in a combustion chamber in a piston engine that comprises an ignition system.

### PRIOR ART

For several functions of internal combustion engines it is important to be able to measure and determine various parameters in the combustion chamber in a reliable manner.

Vital information such as IMEP and HEAT RELEASE can be determined based on the cylinder pressure and an accurate determination of top dead centre. IMEP is an acronym for “Indicated Mean Effective Pressure” and is a measure of the work that the cylinder performs during one working cycle without taking friction losses into account. HEAT RELEASE is the heat that is released by the combustion.

Furthermore, it is important to be able to localise top dead centre (“the upper turning point”) of the engine in a reliable manner in order to make possible spark formation of the spark plug when the piston is in the position that is most advantageous for making the ignition of the fuel-air mixture as efficient as possible, both with respect to function and from the point of view of emissions. The detection of top dead centre must be possible rapidly and correctly for the ignition to be controlled in an optimal manner. The detection must also be possible during operation of the engine.

The methods that are currently used to calibrate the position of top dead centre are time-consuming. For example, a dial indicator can be arranged in the cylinder, and the piston displaced such that a minimum distance between the piston and the cylinder head is achieved. It is subsequently cumbersome to fine-adjust the position that has been adjusted in this manner.

Cylinder pressure is currently determined either with a piezoelectric sensor or with the aid of ionic currents from the combustion process.

The present invention solves the problem with the determination of top dead centre and can be used both before the engine has been started and under revolution of the engine with or without combustion. One advantage is that reading off of the position of top dead centre according to the invention is more exact than when using the previously known methods. The invention also means that the cylinder pressure can be measured even during revolutions in which no combustion takes place.

The present invention also has the advantage that measurement of ion currents, modification of burning time and a multispark function can be carried out in the ignition system in an efficient manner. “Multispark function” is used to denote the delivery by the ignition system of a new spark as soon as the system has been recharged to the correct level.

Furthermore, the method according to the invention provides information about the appearance of the pressure curve not only during combustion but also during revolutions without combustion. This means that an extensive analysis of the combustion process, such as, for example, facts about the current IMEP and HEAT RELEASE, can be obtained with the aid of the invention. Since the invention uses impedance identification, it is also possible to detect leakage currents, soot formation and other defects of the spark plug of the internal combustion engine.

The invention also has the advantage that the measurement voltage level can be directly changed from, for example, a control program without requiring any modification of the hardware of the ignition system. This means increased opportunities with respect to detecting ionic currents.

### SUMMARY OF THE INVENTION

The method of measuring and determining cylinder-specific parameters in a combustion chamber of a piston engine that comprises an ignition system is characterised in that the measurement occurs with the aid of the ignition system in that an alternating voltage is applied across the secondary winding of the ignition coil, after which the value of the current that arises in a co-operating measurement circuit on the secondary side is detected as a function of time. The absolute value of the current depends on the measurement resistance of the measurement circuit, on the inductance and the resistance of the secondary winding and on the characteristic impedance of the combustion chamber, which comprises a capacitance and a resistance. The capacitance of the combustion chamber changes when the position of the piston changes and it has its highest value when the piston is situated at the top dead centre. The secondary current has its highest value when the capacitance reaches its maximum.

The measurement according to the invention can be carried out during revolutions of the engine when no combustion takes place. The measurement can even be carried out by “motoring” the engine before it is started. The measurement can also be carried out during revolutions of the engine when combustion does take place. In this case, by applying a suitable voltage level across the measurement circuit, the ionic current from the combustion process can also be analysed and, in the same way, the burning time of the spark can be increased, or multisparks can be supplied through the application of a voltage across the measurement circuit that is suitable for this purpose.

Other characteristics of the invention are specified in the following claims.

### SHORT DESCRIPTION OF THE DRAWINGS

In the following description of embodiments of the invention reference will be made to the accompanying drawings, in which:

FIG. 1 shows the construction in principle of the secondary circuit according to the invention;

FIG. 2 shows examples of connection of circuits to detect top dead centre according to the invention;

FIG. 3 shows a measurement circuit with a transformer;

FIG. 4 shows a curve for determination of top dead centre;

FIG. 5 shows a measurement circuit with a separate transformer, the secondary winding of which is connected in series with the secondary windings of several ignition coils that are connected in parallel.

### DESCRIPTION OF EMBODIMENTS

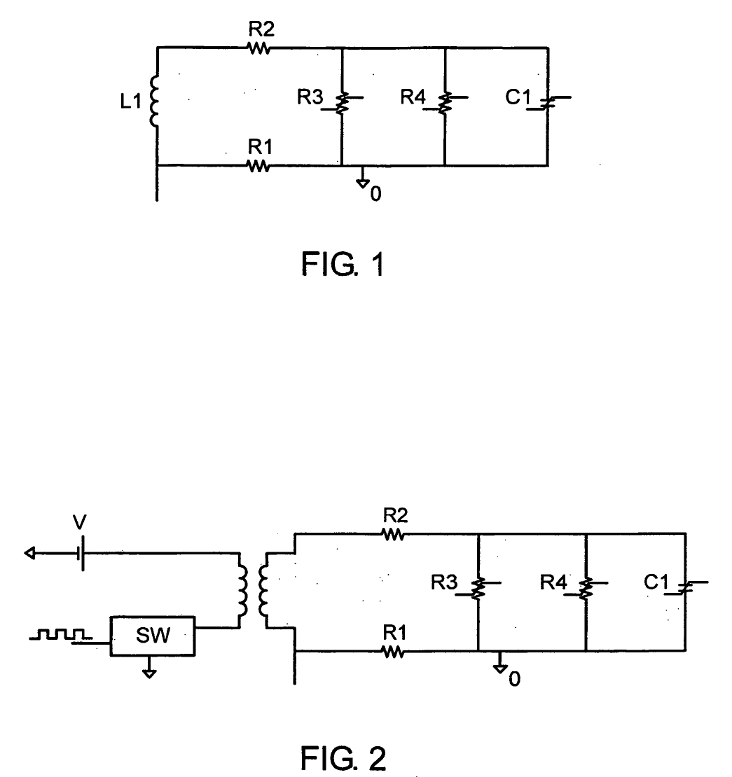

Thus, the secondary current of the ignition coil is used, according to the invention, in order to be able to detect when the piston is located at top dead centre. FIG. 1 shows the construction in principle of a secondary circuit for the detection. The measurement circuit comprises, in addition to a measurement resistance R1, the inductance L1 of the secondary winding of the ignition coil, the resistance R2 of the secondary circuit and the cylinder impedance that consists of the parallel connection of R3, R4 and C1. A combustion procedure means that the impedance of the combustion chamber is influenced. In order to be able simply to determine the values of R3, R4 and C1, the measurement for a 4-stroke engine should take place during two revolutions of the engine, that is, during one working cycle. During the cycle in which combustion does not take place, which is usually denoted as the “waste”-cycle, the impedance is influenced only by the position of the piston and not by the pressure or by the ionic current (R4). During the combustion phase, the impedance is influenced also by the compressive pressure. When compression and leakage effects remain but no combustion takes place, the compression and the leakage resistance (R3) can be measured. By changing the frequency of the measurement signal, the value of the capacitance C1 can be separated from the value of the leakage resistor R3, on the condition that no ionic current is present (combustion is not taking place). The separation of the various resistances for a 2-stroke engine can take place by producing a deliberate misfiring, for example, by switching off the ignition or fuel supply, or by turning the engine over manually or with the starter motor before combustion is started. A further alternative for doing this is to measure during that part of the working cycle during which ionic current is not present.

Based on the circuit if FIG. 1, the voltage across the measurement resistor can be expressed with the aid of a Laplace transform according to (1): where.

$$\begin{matrix}{V}_{meas} = - {I}_{s} ( {R}_{2} + {sL}_{1} + \frac{{R}_{3} {R}_{4} {C}_{1}}{{R}_{4} {sC}_{1} + {R}_{3} {sC}_{1} + {R}_{3} {R}_{4}} ) where & ( 1 ) \\ {I}_{s} = \frac{{V}_{meas}}{{R}_{1}} & ( 2 )\end{matrix}$$

and where Vₘₑₐₛ is the voltage across the measurement resistor, Iₛ is the current in the secondary circuit, R₁ is the measurement resistance, sL₁ is the impedance of the secondary winding, R₂ is the resistance of the secondary circuit and 1/sC₁, R₃ and R₄ comprise the characteristic impedance of the combustion chamber.

The capacitance of the combustion chamber C₁ depends on, among other factors, the position of the piston, the composition of the gas, the temperature and the cylinder pressure.

When the piston in the cylinder moves, the cylinder capacitance C₁ changes and thus affects the impedance of the secondary circuit. The change can be measured by means of the voltage Vₘₑₐₛ. Top dead centre can be detected in this way, since the capacitance of the cylinder reaches its highest value at top dead centre. The absolute value of the secondary current Iₛ thus has its highest value at top dead centre, if no combustion takes place. It can be seen from equations (1) and (2) that it is desirable to use an alternating voltage in the secondary circuit in order to be able to measure the change in impedance during motion of the piston.

One method for generating alternating current for the detection of top dead centre of a piston cylinder is shown in FIG. 2. In addition to the secondary circuit, which agrees with that shown in FIG. 1, a battery of voltage V₁ is shown on the primary side of an ignition coil T1 connected to one end of the primary winding of the ignition coil, the second end of which is connected to a switch SW that is controlled by a control signal t.

Thus, according to the invention, the primary winding of the ignition coil can be used to apply an alternating voltage across the spark plug. The frequency of the alternating voltage can be varied, whereby the resistance of the combustion chamber is determined, which value of resistance is equivalent to the insulation resistance in the high-tension section of the ignition system.

According to one embodiment of the invention, top dead centre can be detected during revolutions of the engine when combustion is taking place. The same measurement circuit can then be used to analyse the ionic current from the combustion process. In this case, the primary winding is used to generate not only a spark, but also alternating voltage for the detection of top dead centre. The use of the same primary winding both for high tension and for measurement of the ionic current, which is thus accomplished by a special connection, means that the available space within the engine compartment is used more efficiently since no extra coils need to be added. Furthermore, the invention can be applied to existing ignition coils.

In another embodiment, an ignition coil is used that has double primary windings whereby one winding is used for spark voltage and one winding is used for the detection of top dead centre and for analysis of the ionic current.

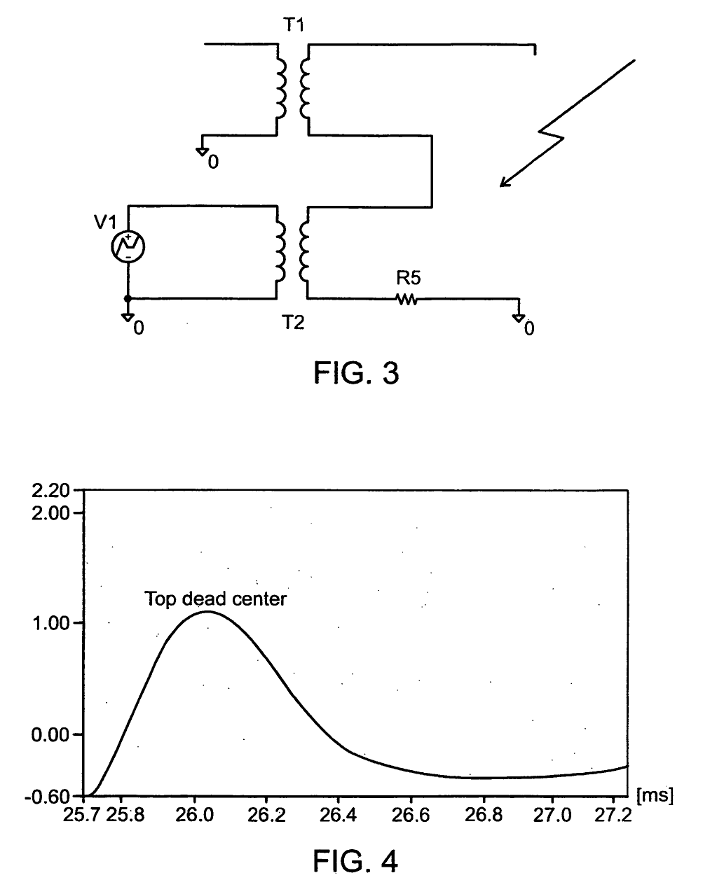

An alternative method for the analysis of the ionic current is to use an ionic current transformer T₂ with a separate primary winding, the secondary winding of which is placed in series with the secondary winding of the ignition coil T₁, see FIG. 3. In this way, a triangularly shaped voltage, for example, can be applied to the primary winding of the ionic current transformer. This leads to a constant voltage across the output of the ionic current transformer and thus also across the secondary winding of the ignition coil. A variable DC voltage is obtained with which the signal from the ionic current is analysed, see FIG. 3. The circuit according to FIG. 3 can also be used together with curves that have other shapes.

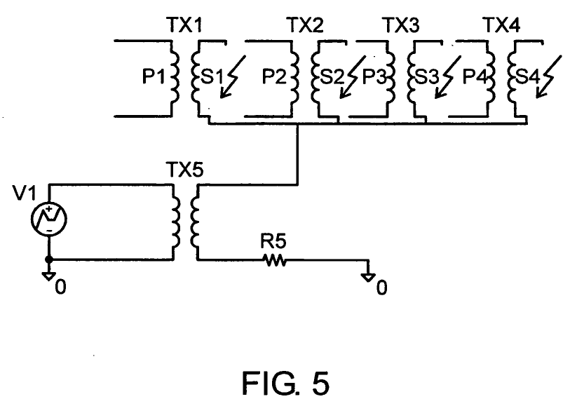

According to one embodiment, the voltage can be applied via the primary winding of a separate transformer, the secondary winding of which is connected in series with the secondary windings of several ignition coils, which coils are connected in parallel, see FIG. 5.

One advantage of the circuit according to FIG. 3 is that no inductive connection between the ignition coil T₁ and the ionic current transformer T₂ is necessary. This is particularly advantageous in designs in which the space available for the ignition coil is small, since the ionic current transformer T₂ can be placed where more space is available.

The measurement of ionic current according to the invention is more dynamic than measurement with known methods, since it makes possible measurement during change of the level of ionic current if the composition of the fuel is changed. With conventional technology for the measurement of ionic currents, this can lead to the ionic current becoming too small or too large for analysis to be possible. With conventional ionic current technology using a fixed voltage level, changes of the system must be accomplished in equivalent cases. With the method according to the invention, the signal amplitude can be changed by, for example, adjusting the frequency of the control signal.

A further advantage of the embodiment according to the invention is that the leakage effects that arise at high temperatures are avoided. These arise in the conventional measurement circuit for ionic current with Zener diodes. The measurement voltage decays at these high temperatures, and the measurement result becomes poorer, something that can be remedied through the method according to the invention.

The circuit according to the invention can also be used to prolong the burning time of the spark or both to prolong the burning time of the spark and to analyse the ionic current. This combination is advantageous since a problem that is currently present with ignition coils with long burning times is that they risk disturbing the measurement of ionic current. The burning time can be extended with the aid of the invention also for those cycles in which measurement of the ionic current is not necessary. The possibility also exists, only by altering the frequency of the switching, for a very rapid spark generation with high energy and with a short time interval between each spark, something that is known as multisparking.

According to one embodiment of the invention, the working pressure in the cylinder can be detected by means of the measuring circuit, whereby the maximum pressure lies at the top dead centre of the piston, if combustion does not take place.

FIG. 4 shows an example of measurement results for the detection of top dead centre, in which the signal of the alternating voltage measured across R1 has been processed in order to measure the amplitude of the pressure curve and the position of the pressure maximum.

The method according to the invention can be applied in a capacitive ignition system or in an inductive ignition system.

1. A method to measure and determine cylinder-specific parameters such as pressure, piston position and impedance in a combustion chamber of a piston engine having an ignition system with an ignition coil and spark plugs, characterised in that measurement occurs with the aid of the ignition system through the application of an alternating voltage, that can be changed by a control program, across a secondary winding of the ignition coil, after which the value of the current that arises is detected as a function of time in a measurement circuit that co-operates with the secondary winding, whereby the value of current detected depends on a measurement resistance of the measurement circuit, on an inductance and resistance of the secondary winding and on a characteristic impedance of the combustion chamber, which comprises a capacitance and a resistance, and whereby in addition, the pressure in a cylinder and/or a position of a piston can be determined by means of the value of the current.

2. The method according to claim 1, characterised in that the measurement is carried out during revolutions of the piston engine in which combustion does not take place.

3. The method according to claim 2, characterised in that the measurement is carried out while the piston engine is mechanically motored.

4. The method according to claim 2 or 3, characterised in that the maximum value of the current that arises in the measurement circuit that co-operates with the secondary winding is measured, whereby the highest value of the capacitance of the combustion chamber and this maximum value of the secondary current, that is, the top dead centre, is determined.

5. The method according to claim 2 or 3, characterised in that the frequency of the alternating voltage is varied, whereby the value of the resistance of the combustion chamber is determined, which value of the resistance is equivalent to the insulation resistance in the high-tension section of the ignition system.

6. The method according to claim 1, characterised in that the measurement is carried out during revolutions of the engine during which combustion takes place.

7. The method according to claim 6, characterised in that the measurement is carried out during that part of the engine revolution during which combustion does not take place, whereby the frequency of the alternating voltage is varied and the value of the resistance of the combustion chamber is determined, which value of the resistance is equivalent to the insulation resistance of the high-tension section of the ignition system.

8. The method according to claim 7, characterised in that the burning time of the ignition spark can be changed by means of applying a changed voltage level across the measurement circuit.

9. The method according to claim 7, characterised in that an ionic current from the combustion process is analysed by means of the measurement circuit.

10. The method according to claim 7, characterised in that both analysis of an ionic current and increased burning time of the spark are generated by the measurement circuit.

11. The method according to any one of the preceding claims, characterised in that the alternating voltage that can be changed is applied through a primary winding of an existing ignition coil.

12. The method according to claim 11, characterised in that the ignition coil comprises more than one primary winding.

13. The method according to any one of claims 1-10, characterised in that the alternating voltage that can be changed is applied through a primary winding of a separate transformer, the secondary winding of which is placed in series with the secondary winding of the ignition coil.

14. The method according to any one of claims 1-10, characterised in that the alternating voltage that can be changed is applied via a primary winding of a separate transformer, the secondary winding of which is connected in series with the secondary windings of several ignition coils, which coils are connected in parallel.

15. The method according to any one of claims 1-14, characterised in that the ignition voltage of the ignition system is generated in an inductive ignition system.

16. The method according to any one of claims 1-14, characterised in that an ignition voltage of the ignition system is generated in an inductive ignition system.
